(19) United States
(12) Patent Application Publication
(10) Pub. No.: US 2013/0282537 A1
(43) Pub. Date: Oct. 24, 2013

(54) UTILIZING MULTIPLE VERSIONS OF FINANCIAL ALLOCATION RULES IN A BUDGETING PROCESS

(71) Applicant: David Snider, Bellevue, WA (US)

(72) Inventor: David Snider, Bellevue, WA (US)

(73) Assignee: Apptio, Inc., Bellevue, WA (US)

(21) Appl. No.: 13/452,628

(22) Filed: Apr. 20, 2012

(51) Int. Cl. G06Q 40/00

(52) U.S. Cl. 705/30

(57) ABSTRACT

Embodiments are directed towards budgeting and financial forecasting related to information technology and services. Budgets may comprise one or more, model layers that may include cost objects and one or more allocation rules. Users may create and modify a budget and modifications made to a budget may generate corresponding change entries that may be stored in an audit log. Also, users may create and/or record tags that may be associated with change entries that may correspond to a snapshot of the state of the budget main branch. Users may use a tag to generate one or more new budget versions based on the change entries that may be associated with the tag. The new budget versions may be further modified by the user separate from the budget each other budget. Also, budget versions may have different cost objects and/or allocation rules.

### TECHNICAL FIELD

The present invention relates generally to computer automated activity based budgeting, forecasting, cost accounting, and more particularly, but not exclusively to creating multiple versions of budget models and generating comparisons between the various budget versions.

### BACKGROUND

Businesses that strive to remain viable and successful in today's competitive commercial environment are required to adopt accurate and responsive budgeting and accounting practices. To improve efficiency, businesses use complex budget models that apply modern budgeting, forecasting, and cost accounting techniques. For some modern accounting techniques, complexity may increase significantly as the number of tracked activities and elements increase. Therefore, for larger enterprises, sophisticated computer programs and computing devices are often required to assist in generating useful and relevant budgets based on financial allocation models.

Developing a budget is often requires an iterative process that receives input from many sources. During the budgeting process, budget makers may create several proposed budgets before determining a final budget. Also, from a final budget, several forecast budgets may be created for predicting future costs and expenses.

In many cases, having numerous proposed and forecasting budgets can be difficult for decisions makers to analyze. Further, it can be difficult to make meaningful comparisons between the different related budgets. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical schematic of a budget in accordance with the embodiments;

FIG. 5 illustrates a partial view of a data store in accordance with the embodiments;

FIG. 6 illustrates a process for general budgeting and forecasting in accordance with the embodiments;

FIG. 7 shows a flow chart generally showing one embodiment of an overview process for use in budget versioning in accordance with the embodiments;

FIG. 8 shows a flow chart generally showing one embodiment of an overview process for use in creating a budget version in accordance with the embodiments;

FIG. 9 shows a flow chart generally showing one embodiment of an overview process for use in comparing budget versions in accordance with the embodiments;

FIG. 10 shows a flow chart generally showing one embodiment of an overview process for use in executing cross version metric calculations in accordance with the embodiments; and

FIG. 11 illustrates a partial view of results from a cross version metric calculation in accordance with the embodiments.

### DESCRIPTION OF THE VARIOUS EMBODIMENTS

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “Financial allocation model,” refers to a graph based representation of a system of financial allocation rules that can be used for costing actual expenditures (for management accounting) or budgeting future expenditures. Nodes in the model may represent classes of items that may be associated with costs and/or expenses. The edges of the graph may represent how the costs and/or expenses may be allocated between the nodes. A financial allocation model may be a visual rendering of a graph showing the nodes and the edges connecting the nodes.

As used herein, the term “Cost line item,” refers to a single line item in a budget (or finance allocation model) and its associated cost/expense. For example, the costs associated with a particular computer that is the email server may be a single item having a particular cost (e.g., the email server may correspond to a cost line item).

As used herein, the term “Cost object,” refers to a set and/or class of cost line items that may be grouped together. For example, a collection of computers performing services such as email, web serving, enterprise resource planning, may represent separate cost line items and they may be grouped into the cost object Servers.

As used herein, the terms “Allocation rules” or “entity propagation rules,” may be used interchangeably and refer to rules in the financial allocation model that determine how the costs/expenses from a cost object are allocated and/or propagated between/among other cost objects. Also, allocation rules may be assigned to individual cost line items. For example, if an email server cost line item has a value of $1000 an allocation rule may be defined such that 50% of the expense may be allocated to the Marketing department and 50% may be allocated to the Engineering department. Also, allocation rules may be applied at the cost object as well as the cost line item level.

As used herein, the term “work stream,” refers to records that may be stored in a data store to preserve of the actions and events that may have been taken to generate a budget in accordance with at least one of the various embodiments. In general, a budget may be a combination of an associated work stream and associated data. In at least one of the various embodiments, a budget may be generated from a work stream and appropriate source data. In at least one of the various embodiments, a work stream may be implemented as an audit log.

As used herein, the term “change entry,” refers to individual elements that may be combined and/or collected into a work stream. Each change entry may be a record of one or more actions and/or state changes made to generate a budget as part of the budgeting process.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed towards budgeting and financial forecasting related to information technology and services. In at least one of the various embodiments, budgets may comprise one or more, model layers that may include cost objects and one or more allocation rules. In at least one of the various embodiments, users may create and modify a budget main branch. In at least one of the various embodiments, modifications made to a budget version may generate corresponding change entries that may be stored in an audit log.

In at least one of the various embodiments, users may create and/or record tags that may be associated with change entries that may correspond to a snapshot of the state of the budget main branch. In at least one of the various embodiments, users may use a tag to generate one or more new budget versions based on the change entries that may be associated with the tag. In at least one of the various embodiments, the new budget versions may be further modified by the user separate from the budget main branch. Also, in at least one of the various embodiments, budget versions may have different cost objects and/or allocation rules.

In at least one of the various embodiments, multiple budget versions may be compared by using cross version metric calculations that may enable budget managers to meaningfully compare different budget versions.

### Illustrative Operating Environment

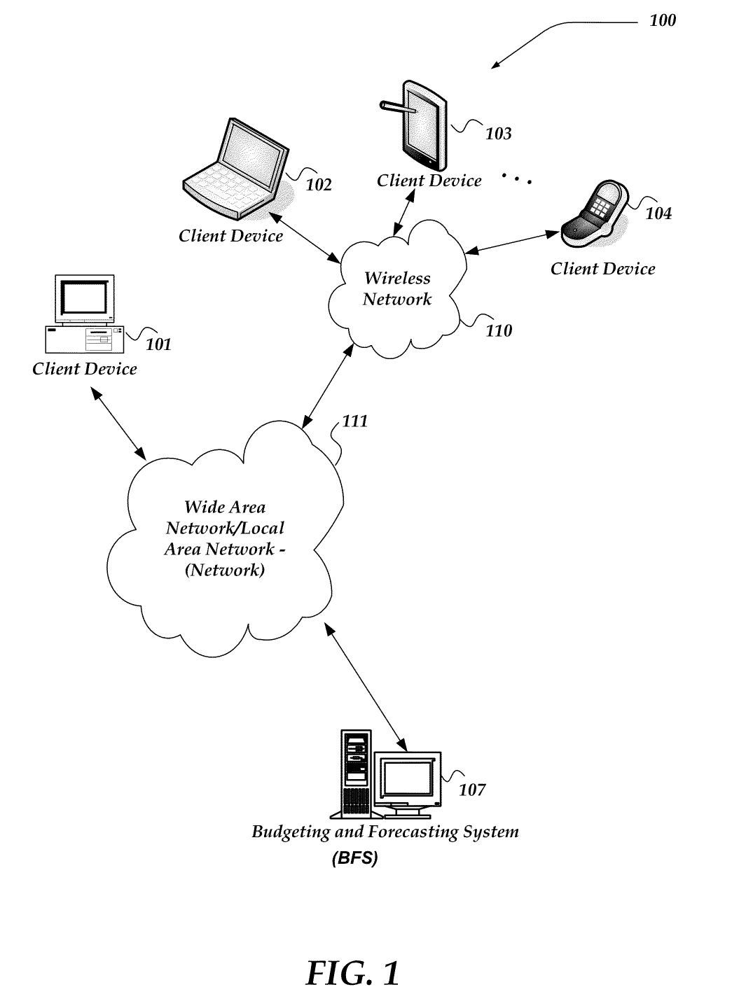

FIG. 1 shows components of one embodiment of an environment in which the invention may be practiced. Not all the components may be required to practice various embodiments, and variations in the arrangement and type of the components may be made. As shown, system 100 of FIG. 1 includes local area networks (“LANs”)/wide area networks (“WANs”)—(network) 111, wireless network 110, client devices 101-104, and Budgeting and Forecasting System (BFS) 107.

Generally, client devices 102-104 may include virtually any portable computing device capable of receiving and sending a message over a network, such as network 111, wireless network 110, or the like. Client devices 102-104 may also be described generally as client devices that are configured to be portable. Thus, client devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. As such, client devices 102-104 typically range widely in terms of capabilities and features. For example, a cell phone may have a numeric keypad and a few lines of monochrome Liquid Crystal Display (LCD) on which only text may be displayed. In another example, a web-enabled mobile device may have a touch sensitive screen, a stylus, and several lines of color LCD in which both text and graphics may be displayed.

Client device 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of client devices 102-104 may operate over wired and/or wireless network. Today, many of these devices include a capability to access and/or otherwise communicate over a network such as network 111 and/or even wireless network 110. Moreover, client devices 102-104 may access various computing applications, including a browser, or other web-based application.

In one embodiment, one or more of client devices 101-104 may be configured to operate within a business or other entity to perform a variety of services for the business or other entity. For example, client devices 101-104 may be configured to operate as a web server, an accounting server, a production server, an inventory server, or the like. However, client devices 101-104 are not constrained to these services and may also be employed, for example, as an end-user computing node, in other embodiments. Further, it should be recognized that more or less client devices may be included within a system such as described herein, and embodiments are therefore not constrained by the number or type of client devices employed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client device may employ the browser application to perform various actions over a network.

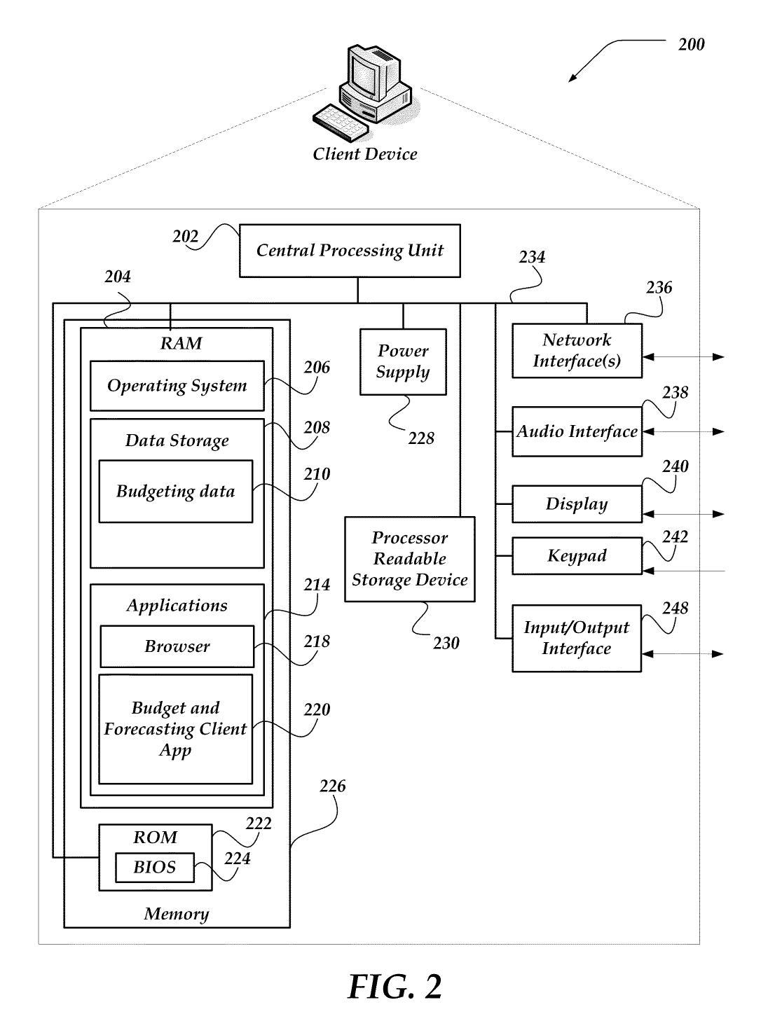

Client devices 101-104 also may include at least one other client application that is configured to receive and/or send data, including budgeting and forecasting information, between another computing device. The client application may include a capability to provide requests and/or receive data relating to a budget versions generated from a plurality of budgets. In some embodiments, the client application may employ processes such as described below in conjunction with FIGS. 2-11 to perform at least some of its actions.

Wireless network 110 is configured to couple client devices 102-104 and its components with network 111. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. In essence, wireless network 110 may include virtually any wireless communication mechanism by which information may travel between client devices 102-104 and another computing device, network, or the like.

Network 111 is configured to couple network devices with other computing devices, including, BFS 107, client device(s) 101, and through wireless network 110 to client devices 102-104. Network 111 is enabled to employ any form of computer readable media for communicating information from one electronic device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within network 111 and wireless network 110. Furthermore, remote computers and other related electronic devices could be remotely connected to either LANs or WANs via a modem and temporary telephone link. In essence, network 111 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

BFS 107 may include virtually any network device usable to provide budgeting and forecasting management services, such as network device 200 of FIG. 2. In one embodiment, BFS 107 employs various techniques to create and define budgets and budget versions. In at least one of the various embodiments, budget versions may be created and used for comparing and forecasting budgets. Also, in at least one of the various embodiments, budget versions may be created based in part on the change entries, work streams, or audit logs of a parent budget. Further, in at least one of the various embodiments, BFS 107 may be arranged to compare budget versions using one or more cross project metrics that may be valuated against multiple budget versions.

Devices that may operate as BFS 107 include various network devices, including, but not limited to personal computers, desktop computers, multiprocessor systems, microprocessor-based or programmable consumer electronics, network PCs, server devices, network appliances, or the like. It should be noted that while BFS 107 is illustrated as a single network device, the invention is not so limited. Thus, in another embodiment, BFS 107 may represent a plurality of network devices. For example, in one embodiment, BFS 107 may be distributed over a plurality of network devices and/or implemented using cloud architecture.

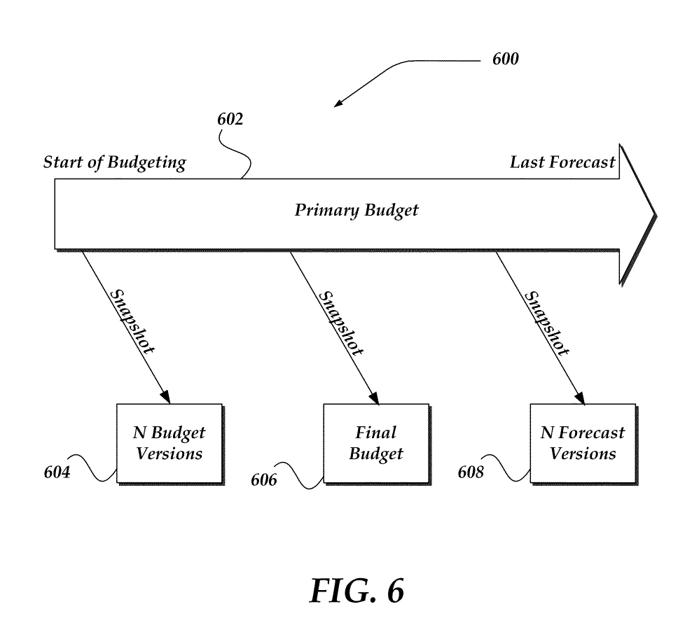

Moreover, BFS 107 is not limited to a particular configuration. Thus, BFS 107 may operate using a master/slave approach over a plurality of network devices, within a cluster, a peer-to-peer architecture, and/or any of a variety of other architectures. Thus, BFS 107 is not to be construed as being limited to a single environment, and other configurations, and architectures are also envisaged. BFS 107 may employ processes such as described below in conjunction with FIGS. 6-10 to perform at least some of its actions.

### Illustrative Client Device

FIG. 2 shows one embodiment of client device 200 that may be included in a system implementing embodiments of the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-104 of FIG. 1.

As shown in the figure, client device 200 includes a central processing unit (“CPU”) 202 in communication with a mass memory 226 via a bus 234. Client device 200 also includes a power supply 228, one or more network interfaces 236, an audio interface 238, a display 240, a keypad 242, and an input/output interface 248. Power supply 228 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 236 includes circuitry for coupling client device 200 to one or more networks, and is constructed for use with one or more communication protocols and technologies including, but not limited to, global system for mobile communication (“GSM”), code division multiple access (“CDMA”), time division multiple access (“TDMA”), user datagram protocol (“UDP”), transmission control protocol/Internet protocol (“TCP/IP”), short message service (“SMS”), general packet radio service (“GPRS”), WAP, ultra wide band (“UWB”), IEEE 802.16 Worldwide Interoperability for Microwave Access (“WiMax”), session initiated protocol/real-time transport protocol (“SIP/RTP”), or any of a variety of other wireless communication protocols. Network interface 236 is sometimes known as a transceiver, transceiving device, or network interface card (“NIC”).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action. Display 240 may be a liquid crystal display (“LCD”), gas plasma, light emitting diode (“LED”), or any other type of display used with a computing device. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Client device 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Mass memory 226 includes a Random Access Memory (“RAM”) 204, a Read-only Memory (“ROM”) 222, and other storage means. Mass memory 226 illustrates an example of computer readable storage media (devices) for storage of information such as computer readable instructions, data structures, program modules or other data. Mass memory 226 stores a basic input/output system (“BIOS”) 224 for controlling low-level operation of client device 200. The mass memory also stores an operating system 206 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Mass memory 226 further includes one or more data storage 208, which can be utilized by client device 200 to store, among other things, applications 214 and/or other data. For example, data storage 208 may also be employed to store information that describes various capabilities of client device 200. The information may then be provided to another device based on any of a variety of events, including being sent as part of a header during a communication, sent upon request, or the like. At least a portion of the information may also be stored on a disk drive or other computer-readable storage device (not shown) within client device 200. Further, as illustrated, data storage 208 may also store object relationship data 210. In some embodiments, budgeting data 210 may include a database, text, spreadsheet, folder, file, or the like, that may be configured to maintain and store various budget data, audit logs, device data, or the like. Such budgeting data 210 may also be stored within any of a variety of other computer-readable storage devices, including, but not limited to a hard drive, a portable storage device, or the like, such as illustrated by non-transitory computer-readable storage device 230. In yet other embodiments, data storage 208 may also store data associated with budget models that maybe part of one or more budgets.

Applications 214 may include computer executable instructions which, when executed by client device 200, transmit, receive, and/or otherwise process network data. Examples of application programs include, but are not limited to calendars, search programs, email clients, IM applications, SMS applications, voice over Internet Protocol (“VoIP”) applications, contact managers, task managers, transcoders, database programs, word processing programs, security applications, spreadsheet programs, games, search programs, and so forth. Applications 214 may include, for example, browser 218 and budget and forecasting client application 220.

Browser 218 may include virtually any application configured to receive and display graphics, text, multimedia, and the like, employing virtually any web based language. In one embodiment, the browser application is enabled to employ HDML, WML, WMLScript, JavaScript, SGML, HTML, XML, and the like, to display and send a message. However, any of a variety of other web-based languages may be employed. In one embodiment, browser 218 may enable a user of client device 200 to communicate with another network device, such as BFS 107 of FIG. 1. In one embodiment, browser 218 may enable a user to view and/or manipulate budgets, including creating budgets, modifying budget models, creating budget versions, comparing budget versions, or the like.

In at least one of the various embodiments, a user may employ client device 200 to create and manage budgeting and forecasting projects and to access information stored or otherwise managed through BFS 107. In at least one of the various embodiments, a user may supply various types of data to a budgeting and forecasting system operating on a remote BFS 107. The supplied data may be interrelated as might arise within business systems, spreadsheet type data, or the like. Also, in at least one of the various embodiments, the user may be enabled to perform a variety of actions on the data, including, queries, comparisons, summations, analysis, or the like. Also, in at least one of the various embodiments, a user may employ client 200 to create one more budget versions where modifications made to each budget version may be recorded in an audit log. In at least one of the various embodiments, budgeting and forecasting client application 220 may be arranged to enable a user to create budget versions based on work streams, change entries, or audit logs of parent budget versions as further discussed below.

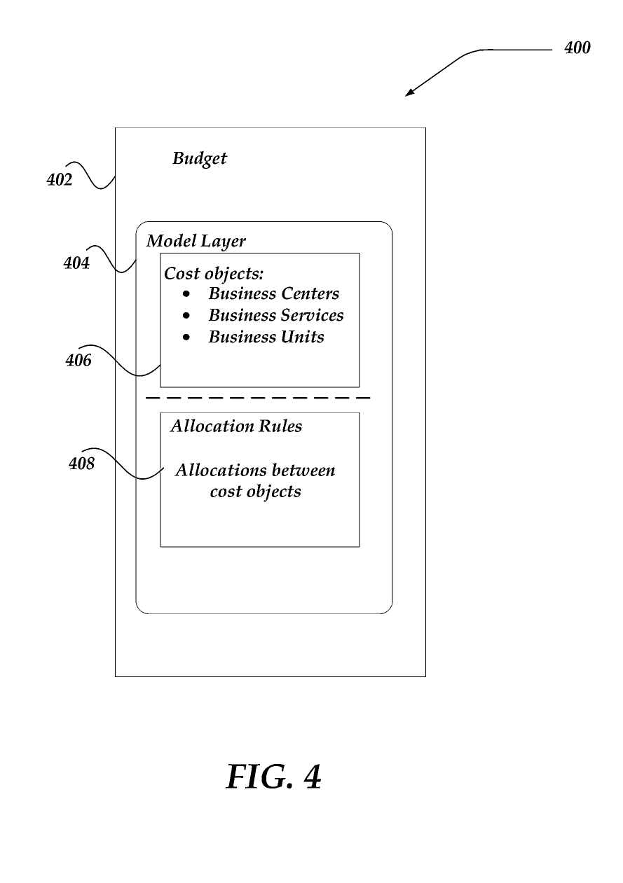

In any event, budget and forecasting client application 220 may employ processes similar to those described below in conjunction with FIGS. 4-11 to perform at least some of its actions.

### Illustrative Network Device

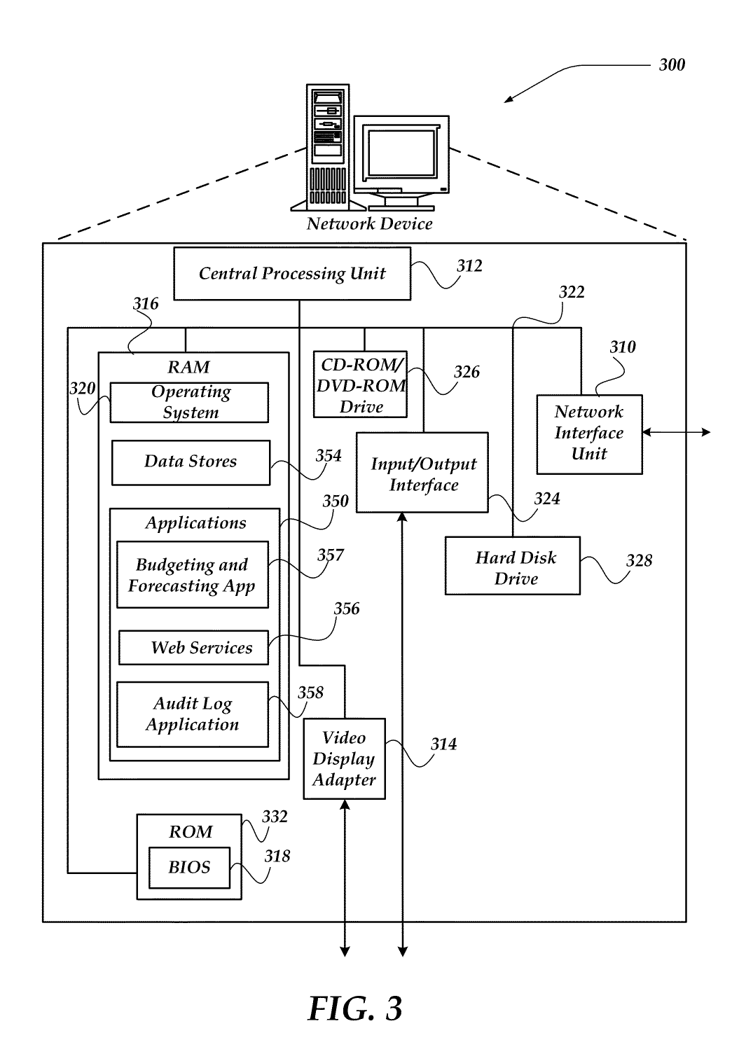

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may represent, for example, BFS 107 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, flash drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC). Network device 300 also includes input/output interface 324 for communicating with external devices, such as a headset, or other input or output devices not shown in FIG. 3. Input/output interface 324 can utilize one or more communication technologies, such as USB, infrared, Bluetooth™, or the like.

The mass memory as described above illustrates another type of computer-readable media, namely computer-readable storage media. Computer-readable storage media (devices) may include volatile, nonvolatile, removable, and non-removable media implemented in any method or technology for storage of information, such as computer readable instructions, data structures, program modules, or other data. Examples of computer readable storage media include RAM, ROM, Electronically Erasable Programmable Read-Only Memory (EEPROM), flash memory or other memory technology, Compact Disc Read-Only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computing device.

As shown, data stores 354 may include a database, text, spreadsheet, folder, file, or the like, that may be configured to maintain and store various budget data, audit logs, device data, or the like. Data stores 354 may further include program code, data, algorithms, or the like, for use by a processor, such as central processing unit (CPU) 312 to execute and perform actions. In one embodiment, at least some of data and/or instructions stored in data stores 354 might also be stored on another device of network device 300, including, but not limited to cd-rom/dvd-rom 326, hard disk drive 328, or other computer-readable storage device resident on network device 300 or accessible by network device 300 over, for example, network interface unit 310.

The mass memory also stores program code and data. One or more applications 350 are loaded into mass memory and run on operating system 320. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Mass memory may also include budgeting and forecasting application 357, web services 356, and audit log application 358.

Web services 356 represent any of a variety of services that are configured to provide content, over a network to another computing device. Thus, web services 356 include for example, a web server, a File Transfer Protocol (FTP) server, a database server, a content server, or the like. Web services 356 may provide the content over the network using any of a variety of formats, including, but not limited to WAP, HDML, WML, SGML, HTML, XML, compact HTML (cHTML), extensible (xHTML), or the like.

In one embodiment, web services 356 may provide an interface for accessing and manipulating data in a data store, such as data stores 354, or the like. In another embodiment, web services 356 may provide for interacting with a budgeting and forecasting application 357 that may enable a user to access and/or otherwise manage budgeting and forecasting services that may be provided through network device 300.

In at least one of the various embodiments, audit log application 358, may include a record of modifications made to a budget since the budget was created. In at least one of the various embodiments, individual records entries in the audit log 358 may be undone or redone as necessary. In at least one of the various embodiments, audit logs may be work streams comprising one or more change entries.

In at least one of the various embodiments, budgeting and forecasting application 357 may enable operators to enter budget items, allocation rules, establish calculation schedules, or the like. Also, in at least one of the various embodiments, the budgeting and forecasting application 357 may enable budget versions to be created based on audit logs, work streams, or change entries that may be associated with parent budget versions. Further, in at least one embodiment, the budgeting and forecasting application 357 may enable cross project metric calculations that may further enable budget comparisons.

In any event, web services 356, budgeting and forecasting application 357, and/or audit log application 358 may employ processes, or parts of processes, similar to those described in conjunction with FIGS. 4-11 to perform at least some of its actions.

### Generalized Operation

FIG. 4 illustrates a budget 400 for at least one of the various embodiments. A budget 400 may be a representation of a budget generated based on a financial allocation model. In at least one of the various embodiments, budgets may track time independently and separate from other budgets. This may enable budgets to have different or separate start dates, end dates, fiscal years, or the like. In at least one of the various embodiments, budgets may be configured to represent a time range that may be advantageous for the particular budget being modeled. (E.g., 1 month, 3 months, 1 year, 5 years, or the like.) Also, in at least one of the various embodiments, budgets may be arranged to reference one or more time increments ranging from days to years.

In at least one of the various embodiments, a budget may have a model layer 404 that includes the logical representation of all the entities, services, and items considered to be addressed by the budget. In at least one of the various embodiments, the model layer 404 may include one or more cost objects 406 that may represent the entities, services, and items, that may be included in the budget. In at least one of the various embodiments, cost objects 406 may include budget centers, business services, business units, servers, laptops, desktops, mobile devices, storage, projects, work tickets (such as for a help desk), cost centers, general ledger transactions, sub-ledger line items, rate cards, or the like. In most cases, a model layer 404 may be comprised of cost objects 406 that represent the particular items a business intends to manage within a particular budget. Accordingly, each budget may include a set of cost objects that may be unique for each business.

In at least one of the various embodiments, cost objects 406 may be implemented using software modules arranged to model objects 406 in a budget 400. One of ordinary skill in the art will appreciate that such objects may be implemented using one or more computer programming languages, computer scripting languages, database stored procedures, or the like. Further, in at least one of the various embodiments, cost objects 406 may be stored and/or implemented using databases, including, SQL databases, object oriented databases, column-oriented databases, NoSQL databases, custom databases, or the like.

In at least one of the various embodiments, a budget's model layer 404 may include allocation rules 408 that may define in part how cost objects 406 relate to each other within the context of a particular budget. In at least one of the various embodiments, allocation rules 408 may be used to define how one object, such as Storage Services, may be allocated among other cost objects. Users may arrange one or more allocation rules to match the entities being modeled within the budget. In at least one of the various embodiments, one or more allocation rules may be defined in part based on templates, user-interface dialog boxes, command-line commands, configuration files, policy rules, business rules, or the like.

In at least one of the various embodiments, allocation rules 408 may determine how budget costs may be propagated through the budget between and among at least the objects that make up the budget.

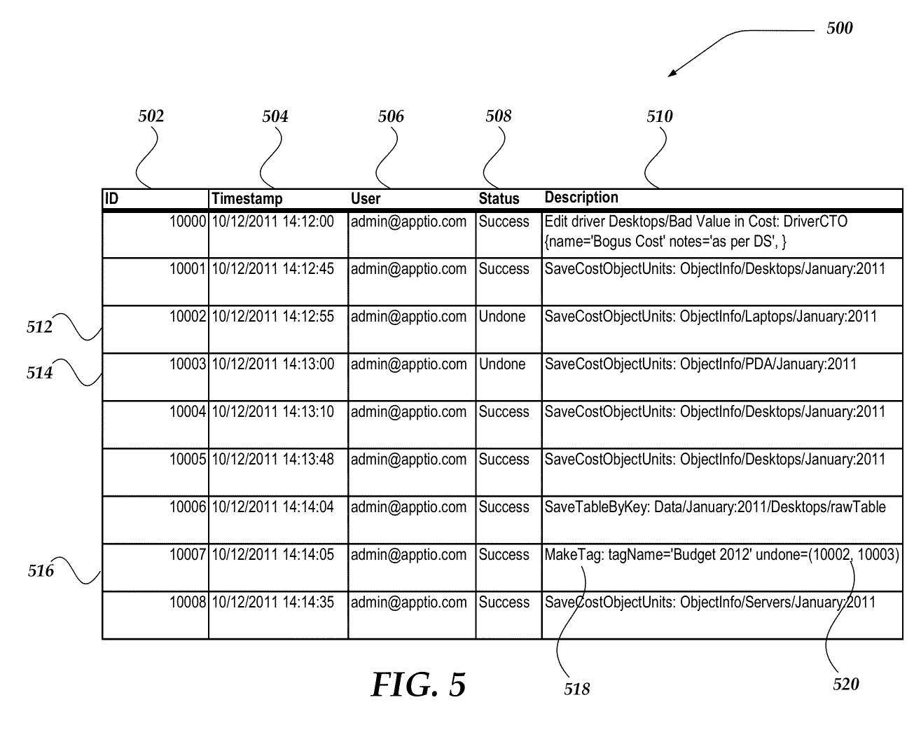

FIG. 5 illustrates a partial view a work stream that may include change entries stored in a data store where the work stream may be implemented as audit log 500 from at least one of the various embodiments. In at least one of the various embodiments, if a modification may be made to a budget version, a change entry corresponding to the modification may be stored in audit log 500.

In at least one of the various embodiments, each recorded change entry in an audit log may include enough information to determine what modification occurred, the time when it occurred (e.g., timestamp), who and/or what caused the modification, or the like. In at least one of the various embodiments, an audit log may include enough information in each record to enable the recorded change entry to be replayed and/or recreated. Also, in at least one of the various embodiments, multiple audit log records (e.g., change entries) associated with one budget may be replayed to create a new budget version that may be a clone of the budget originally associated with the change entries.

In at least one of the various embodiments, audit log 500 may store information, such as, row identifier 502, Timestamp 504, User 506, Status 508, and Description 510, or the like. One of ordinary skill in the art will appreciate that audit logs may be arranged in other ways. In at least one of the various embodiments, audit logs may have more or less values (e.g., columns) per row than depicted in FIG. 5. In at least one of the various embodiments, an arrangement may be sufficient if the audit log includes enough information to enable replaying or recreating the modifications made to a budget from the change entries recorded in the audit log.

Also, in at least one of the various embodiments, audit logs may be altered by marking a record as undone. In at least one of the various embodiments, Status 508 may indicate if an audit log record may have been undone.

For example, in audit log 500, rows 512 and 514 are shown having a Status value that indicates that the recorded modification has been undone. In at least one of the various embodiments, an undone record remains in the audit log with a Status set to indicate that the recorded action has been undone.

Further, in at least one of the various embodiments, an audit log may reference other files, tables, databases, or the like, rather than storing all of the data and information required to recreate the recorded modification directly within audit log 500. For example, in at least one of the various embodiments, if recorded modifications may involve significant data uploads, audit log 500 may reference another source from which to retrieve the uploaded data (e.g., a file system, database, or the like) to avoid storing excessive duplicate data within the audit log itself.

In at least one of the various embodiments, audit logs and/or data stores may be implemented using databases, text files, XML files, or the like. In at least one of the various embodiments, data storage mechanisms that enable persistent and/or reliable storage may be sufficient to implement an audit log and/or data store.

In at least one of the various embodiments, audit log 500 may record information in addition to budget version change entries. In at least one of the various embodiments, an audit log may record additional information such as a tag. A non-limiting example of special change entry, MakeTag 518 is shown as occurring at Timestamp Oct. 12, 2011 14:14:05 in row 516.

In at least one of the various embodiments, a make tag audit log record may indicate that a tag has been created and recorded in audit log 500. In at least one of the various embodiments, a tag may enable a generating a snapshot of the audit log as it exists when the tag was created. In at least one of the various embodiments, if a tag is used to save the state of the audit log, subsequent changes, including modifications or deletions of records in the audit log may occur without altering the tag's snapshot of audit log records (e.g., change entries) saved and/or referenced by the tag.

Accordingly, in at least one of the various embodiments, change entries associated with a tag may be preserved and may be recalled by referencing the associated tag even though the source audit log may have been modified.

In the embodiment shown in FIG. 5, tag 518 named ‘Budget 2012’ may be depicted in an audit log at row 516. In at least one of the various embodiments, a tag record may include list 520 of records that may have been marked as undone. In one embodiment, list 520 may enable preservation of the state of the audit log by preserving the status of each relevant change entry at the time the tag was generated. One of ordinary skill in the art will appreciate that the fields, formats, and descriptions of a tag as used in FIG. 5 is merely one of many variants that may be employed to implement a tag.

Further, one of ordinary skill the art will appreciate that a tag record may be in the audit log, or it may be located elsewhere within the system with a reference the audit log. In at least one of the various embodiments, the state of an audit log associated with a tag may be preserved by recording one or more copies of the audit log records (e.g., change entries) associated with the tag in a separate location, preserving differences between the audit log records associated with a tag and subsequent changes made to the audit log, or the like.

FIG. 6 illustrates one of the various embodiments of a budgeting and forecasting process 600 that may be using budget versioning. In at least one of the various embodiments, a primary budget 602 may be created. As modifications may be made in the primary budget, change entries corresponding to the modification may be recorded in the audit log 500. In at least one of the various embodiments, users may create one or more version snapshots of the primary budget. In at least one of the various embodiments, one or more budget versions may be created that users may manipulate and analyze independent of changes that may occur in primary budget 602 and/or other budget versions. Likewise, in at least one of the various embodiments, users may make modifications to the budget branch versions without affecting the primary budget 602.

In at least one of the various embodiments, budget versions 604 may be used to analyze and propose different/alternative budgets derived from the primary budget. In at least one of the various embodiments, if a budget version may be determined to be a final budget, a budget version may be designated as the final budget 606. Further, in at least one of the various embodiments, budget versions created subsequent to the designated final budget version may be created and used in budget forecasting 608.

In at least one of the various embodiments, each budget version may be generated by replaying change entries that may be associated with a tag representing a snapshot of the state of the primary budget. In at least one of the various embodiments, each budget version may be associated with a tag made in the audit log of primary budget 602.

In at least one of the various embodiments, different budgets and budget versions may be modified independently such that they may contain different allocation rules. In at least one of the various embodiments, modification of the budget versions may include adding, deleting, or modifying the cost objects, allocation rules, budget data, or like. In at least one of the various embodiments, budget data may include the values assigned and/or associated with the cost object and/or rules in the budget versions, such as, money value, quantity, description of items, or the like.

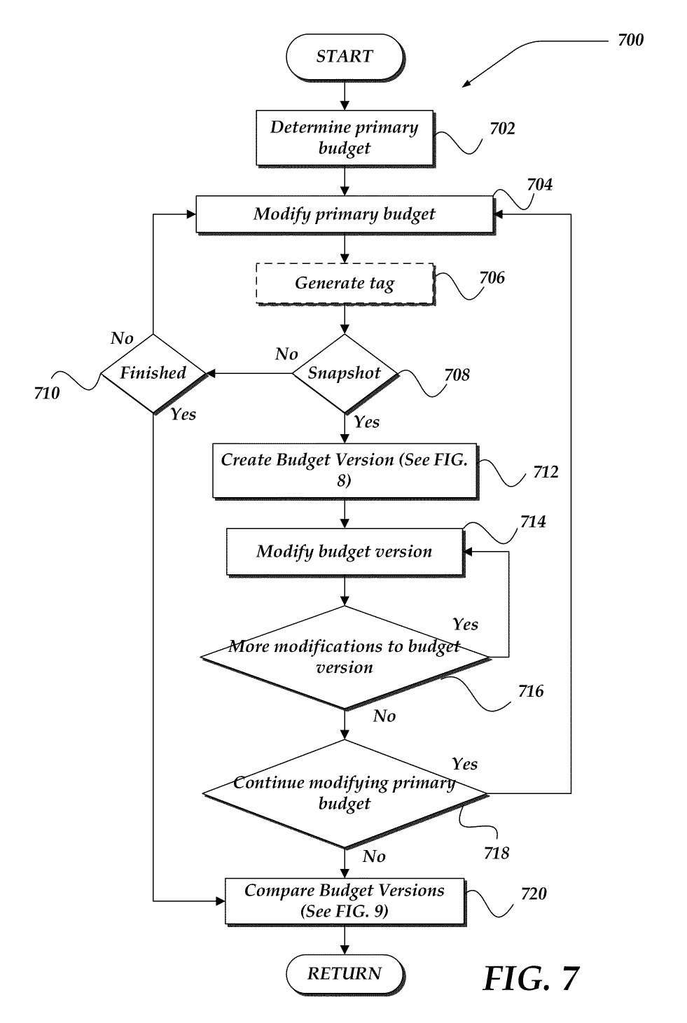

FIG. 7 illustrates a flowchart of one of the various embodiments having process 700 for use in budget versioning. In at least one of the various embodiments, after a start block, at block 702, in at least one of the various embodiments, a primary budget may be determined. In at least one of the various embodiments, a primary budget may be a new budget or it may be based on a template, generated programmatically, fully or partially imported from a third-party system, or the like. Also, in at least one of the various embodiments, the primary budget may be selected from one or more existing budgets that may have been created previously using budgeting and forecasting system 107.

At block 704, in at least one of the various embodiments, the primary budget may be modified. In at least one of the various embodiments, modifications may include configuring the primary budget as required for budgeting and forecasting, including adding, modifying, or deleting cost objects and allocation rules. In at least one of the various embodiments, a change entry corresponding to each modification made to the primary budget may be stored in an audit log.

In at least one of the various embodiments, a user may modify the primary budget using graphical user-interfaces, executing commands at console screens, executing scripts, or the like (on BFS 107). In at least one of the various embodiments, a budget version may be designated as a final budget version. In at least one of the various embodiments, the budgeting entity (e.g., corporation, businesses, company, association, or subdivision thereof) may designate one of the budget versions as a final budget for a specified operative time period (e.g., an annual final budget, three-year final budget, or the like).

At block 706, in at least one of the various embodiments, a tag may be generated preserving the state of the audit log and the primary budget.

At decision block 708, in at least one of the various embodiments, if it is determined that a snapshot of the primary budget may be created, the process may flow block 712. Otherwise, in at least one of the various embodiments, the process may move to decision block 710.

At decision block 710, in at least one of the various embodiments, if modifying the primary budget may be complete, control may flow to block 720. Otherwise, in at least one of the various embodiments, the control may loop back to block 704.

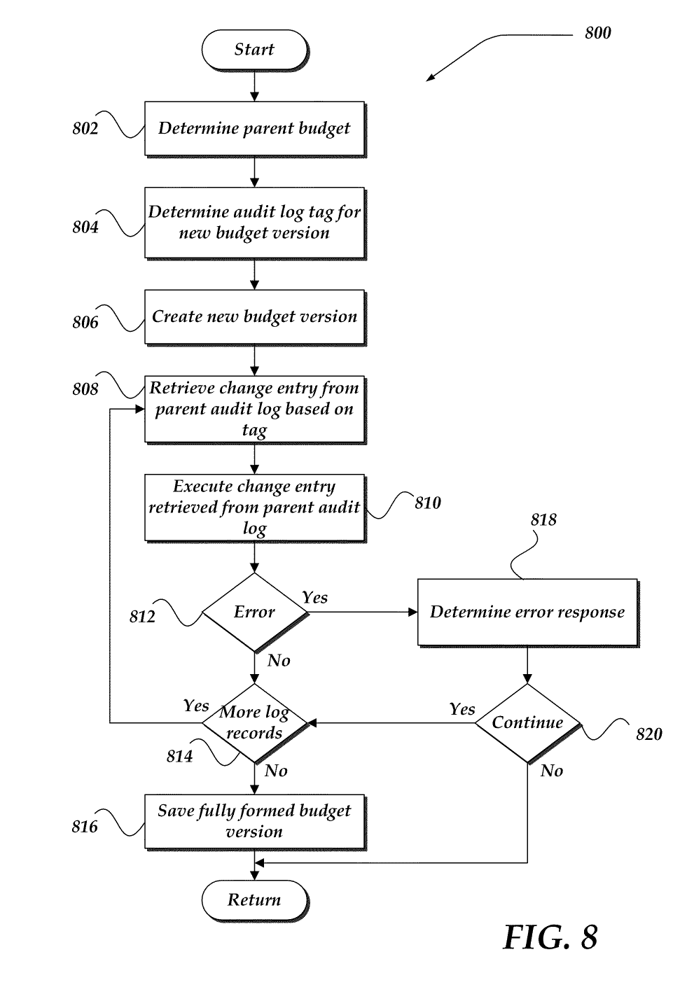

At block 712, in at least one of the various embodiments, a budget version may be created by based on a tag associated with an audit log associated with the primary budget. For at least one of the various embodiments, creating a budget version may be further described below in conjunction with FIG. 8.

At block 714, in at least one of the various embodiments, budget versions may be modified as part of the budgeting process. In at least one of the various embodiments, the modifications to a budget version may be independent from other budget versions or the primary budget. Also, in at least one of the various embodiments, within the new budget version, allocation rules and cost objects may be modified, added, or deleted. In at least one of the various embodiments, this may enable candidate budget proposals and configurations to be tested and/or analyzed without disturbing other budget versions.

In at least one of the various embodiments, each modification to the budget versions may generate a corresponding change entry that may be stored in an audit log or work stream that may be associated with the budget version.

Further, in at least one of the various embodiments, tags may be generated corresponding to the state of the budget versions. In at least one of the various embodiments, such tags may be associated with an audit log and/or stored in an audit log that may be associated with the budget version.

At decision block 716, in at least one of the various embodiments, if more modifications may be made to the budget version, control may loop back to block 714. Otherwise, in at least one of the various embodiments, control may move to decision block 718.

At decision block 718, in at least one of the various embodiments, if more modifications to the primary budget may be processed control may loop back to block 704. Otherwise, in at least one of the various embodiments, control may move to block 720.

At block 720, in at least one of the various embodiments, budget versions may be compared. In at least one of the various embodiments, budget versions may be compared using cross project metric calculations. Next, in at least one of the various embodiments, control may be returned to the calling process.

FIG. 8 is a flow chart generally showing one embodiment of process 800 for use in creating a budget version in accordance with at least one of the various embodiments. After a start block, at block 802, in at least one of the various embodiments, a parent budget may be determined. In at least one of the various embodiments, a parent budget may be selected by users from a collection of budget versions that may already exist. Additionally, in at least one of the various embodiments, parent budgets may be recommended to a user by the BFS 107 based on one or more factors, including, most recently used budget versions, system-wide default settings, client default value settings, or the like. In at least one of the various embodiments, a parent budget may be the primary budget.

At, in block 804, in at least one of the various embodiments, an audit log tag for the new budget may be determined. In at least one of the various embodiments, an audit log(e.g., work stream) of the parent budget may be reviewed and/or scanned to identify tags. In at least one of the various embodiments, if tags may be found, a user may choose among them or, in at least one of the various embodiments, a new tag maybe created by the user.

For example, in at least one of the various embodiments, a user may generate a new budget version based on the primary budget by creating a new tag in the primary budget's audit log. Accordingly, in at least one of the various embodiments, the new tag may be used to identify and preserve all change entries associated with the primary budget that correspond to the state of primary budget.

Similarly, in at least one of the various embodiments, if the user wants to derive the new budget version from a previous state of a parent budget, the user may select a tag from the parent budget's audit log having a timestamp at or around the time preferred by the user. In at least one of the various embodiments, if a tag at the preferred time may be unavailable, a new tag may be created and backdated to capture the preferred state from the parent budget's audit log.

At block 806, in at least one of the various embodiments, a new budget version may be created. In at least one of the various embodiments, the new budget version may begin as an empty budget having no cost objects, no allocation rules, no calculated metrics, or the like. In at least one of the various embodiments, the new budget may have properties such as, name, owner, time of creation, or the like.

At block 808, in at least one of the various embodiments, a change entry associated with the determined tag may be retrieved from the parent budget's audit log.

In at least one of the various embodiments, change entries may be retrieved in time order, working forward in time from the beginning of the parent budget's audit log until the tag may be reached. In at least one of the various embodiments, the mechanism for retrieving the change entry may depend on the configuration and arrangement of the audit log. In at least one of the various embodiments, the change entry may be retrieved by using one or more techniques such as, POSIX-style file system commands (e.g., open( ), close( ), read( ), write( ), lseek( ), etc), database queries, specialized API's, Web Services, XML-RPC, TCP-IP, UDP, or the like.

In at least one of the various embodiments, a process may use a tag to determine if a change entry may be included in a list of “undone” change entries. In at least one of the various embodiments, if the change entry may be in the tag's undone list, the record may not be used and/or retrieved. In at least one of the various embodiments, change entries that may have been marked as “undone” subsequent to the generation of the tag may be retrieved because they may not be in the tag's “undone” list because the “undoing” of the change entry may have occurred after the tag was created.

At block 810, in at least one of the various embodiments, the retrieved change entry may be executed as part of generating the new budget version. In at least one of the various embodiments, executing the retrieved change entry on the new budget version may trigger actions that make the same modifications on the new budget version as were made on the parent budget.

In at least one of the various embodiments, the retrieved change entry may include a function name and a set of named value pairs that may be parameters to the function. In at least one of the various embodiments, the change entry information may be in one or more fields of the audit log, or in a combination of fields and/or columns. For example, the name of the function (e.g., an action) may be in one field or column of the change entry and the parameters may be in other field(s) or column(s). Further, in at least one of the various embodiments, the data and accompanying parameters may be included a self-defining object, or data structure stored and serialized using one or more object serialization techniques that may be supported by available software development libraries.

In at least one of the various embodiments, a process executing retrieved change entries may substitute values that were relevant to the parent budget version with values relevant to the new budget version, such values may include, identifiers, path names, object names, dates, times, or the like.

For example, in at least one of the various embodiments, if a change entry from the parent budget's audit log has a parameter for budget name, the name of the new budget version may be substituted in place of the name of the parent. In at least one of the various embodiments, context oriented parameters may be added at the time of execution relying on the execution of the change entry occurring in the context of the new budget version so appropriate context values may be used.

In at least one of the various embodiments, after executing the retrieved change entry a corresponding change entry may be written into the audit log of the new budget version.

Also, in at least one of the various embodiments, a change entry may be added to the new budget version's audit log referencing (pointing to) the audit log of the parent budget. In at least one of the various embodiments, such a change entry may indicate that the change entries, associated with a particular tag, may be preserved in the parent budget's audit log rather than duplicated in the new budget version's audit log.

At decision block 812, in at least one of the various embodiments, if an error may be detected during execution of the audit log record, control may move to block 818 for determining how to respond to the error. Otherwise, control may move to decision block 814. In at least one of the various embodiments, if additional change entries associated with the determined tag remain to be processed, control may loop back to block 808. Otherwise, in at least one of the various embodiments, control may move to block 816 where the new budget version may be saved and/or made available for use. Next, in at least one of the various embodiments, control may be returned to a calling process.

At block 818, in at least one of the various embodiments, after detecting that an error may have occurred during execution of a change entry, a process may determine the appropriate error response. In at least one of the various embodiments, the response to an error may be based in part on the cause of the error and/or the kind of error. For example, in at least one of the various embodiments, if an error was caused by a lack of available computing resources a process may determine that the action execution process may be queued until the resources may become available to continue processing. Further, in at least one of the various embodiments, if a process determines that the change entry effect causing an error may be ignored and/or bypassed the audit log execution process may continue.

Similarly, in at least one of the various embodiments, the error causing change entry may be flagged and/or recorded for future review. In at least one of the various embodiments, error responses may be determined based on configuration settings that may be supplied by one or more sources, such as, configuration files, rule-based policy instructions, user-interface settings, or the like.

In at least one of the various embodiments, an error response may include notifying a user or a supervisory process. In at least one of the various embodiments, notifications may be enabled using one or more well known methods such as email, text messaging, instant messaging, SNMP alarms, event logging, system logging, user-interface alerts, or the like. In at least one of the various embodiments, some notification properties may be determined by configuration files, policy instructions, and user-interface settings, or the like.

At decision block 820, in at least one of the various embodiments, if the budget version may continue, control may move to decision block 814. Otherwise, in at least one of the various embodiments, if the error response may cause the budget version creation process to stop or abort control may be returned to a calling process.

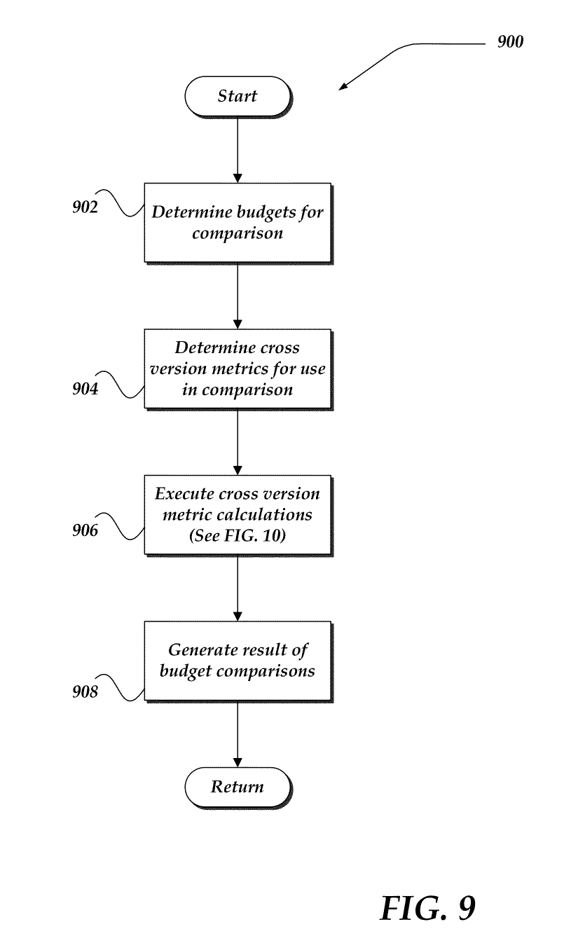

FIG. 9 shows a flow chart generally showing one embodiment of process 900 for use in comparing budget versions in accordance with at least one of the various embodiments. After a start block, in at least one of the various embodiments, at block 902 a set of budget versions to compare against each other may be determined.

At block 904, in at least one of the various embodiments, a process may determine one or more cross project metric calculations for comparing the set of budget versions. In at least one of the various embodiments, cross project metrics may be formulas used for comparing cost objects across multiple budgets and/or budget versions.

In at least one of the various embodiments, cross project metric calculations may include, user-interface driven rules, custom scripts, module plug-ins/add-ins, or the like. In at least one of the various embodiments, cross project metrics may be associated with a family of budget versions (e.g., budgets that may be versions of a common parent budget), associated with one or more budgets, or independent (e.g., part of the BFS 107 but not associated with any particular budget).

In at least one of the various embodiments, cross project metric calculations may reference cost objects in budget versions using one or more techniques including, by name, by reference, relative reference, object groups, object types, keys, GUID's, matching rules (queries), or the like.

In at least one of the various embodiments, a cross project metric may be defined as follows:
<domain name>:<project name>!<metric>

(e.g., company.com:2011 Actuals!Cost)

At block 906, in at least one of the various embodiments, the determined cross project metric calculations may be executed on each of the set of budget versions. At block 908, in at least one of the various embodiments, a process may generate the results of the cross project metric calculations. In at least one of the various embodiments, the results may be reported using tabular format in a user interface, and/or using other well known techniques such as, displaying results on web page, storing in one or more downloadable formatted files (e.g., CSV, XML, fixed length, or the like), storing the results in one or more database tables, or the like. Next, in at least one of the various embodiments, a process may return control to a calling process.

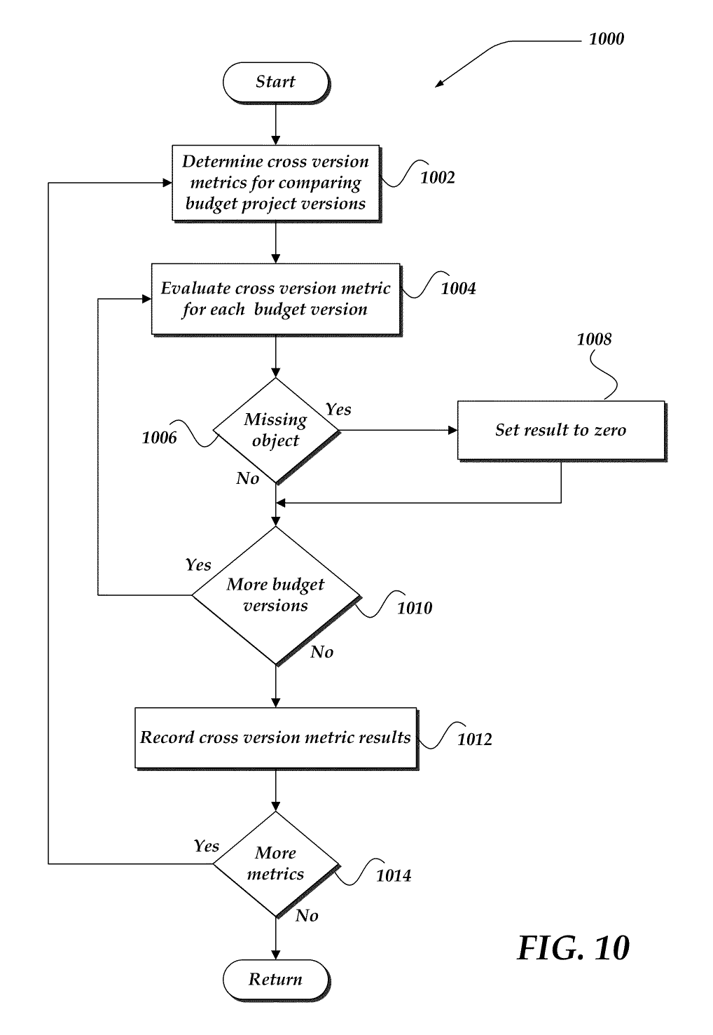

FIG. 10 shows a flow chart generally showing at least one of the various embodiments of process 1000 for use in executing cross version metric calculations in accordance with at least one of the embodiments. After a start block, at block 1002, in at least one of the various embodiments, one or more cross version metric calculations for comparing budget versions may be determined. In at least one of the various embodiments, cross version metric calculations may be determined by a user choosing from a user-interface. Also, in at least one of the various embodiments, cross version metrics may be determined based in part on a template or configuration. Such templates or configurations may group one or more cross version metrics into collections that may be related to analytical goals.

At block 1004, in at least one of the various embodiments, the cross version metric may be evaluated for each of the budget versions in the comparison set.

At decision block 1006, in at least one of the various embodiments, if one or more cost objects called for in the current cross version metric calculation may be absent from one or more of the budget versions control may move to block 1008. Otherwise control may move to block 1010.

At block 1008, in at least one of the various embodiments, the cross version metric result value corresponding to the absent cost object may be set to zero.

At decision block 1010, in at least one of the various embodiments, if unevaluated budget versions remain in the determined comparison set, control may loop back to block 1004. Otherwise, in at least one of the various embodiments, control may move to block 1012.

At block 1012, in at least one of the various embodiments, the results of the cross version metric results may be recorded. In at least one of the various embodiments, results of cross version metric calculations may displayed in a user-interface and/or the results may be stored in database, rendered in a form suitable for printing, presented in one or more formats suitable for downloading and/or exporting to other applications, or the like.

At decision block 1014, in at least one of the various embodiments, if there may be more cross version metrics to evaluate, control may loop back to block 1002. Otherwise, in at least one of the various embodiments, control may be returned to the calling process.

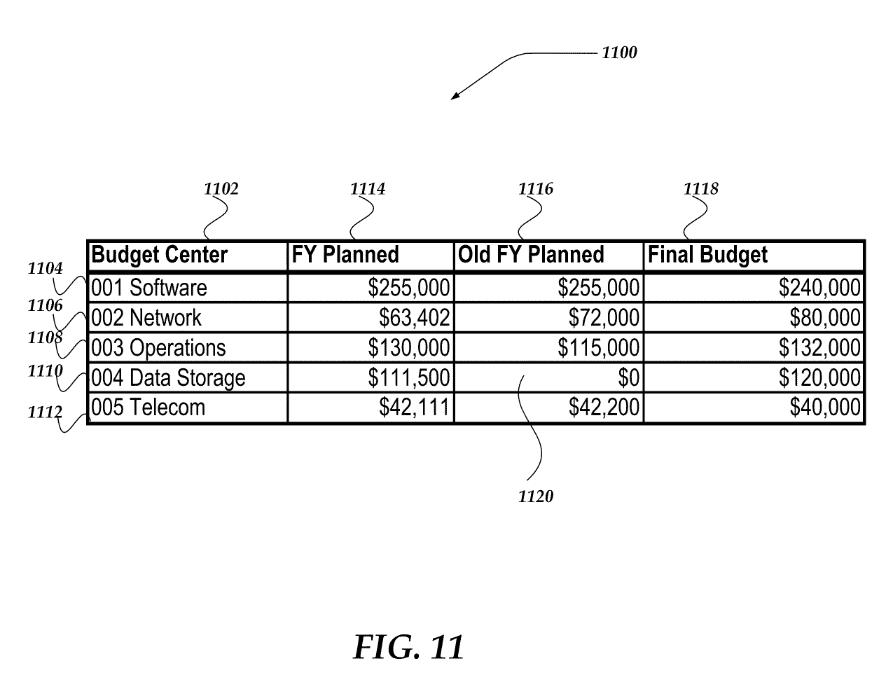

FIG. 11 illustrates results list 1100 that may be generated, in at least one of the various embodiments, using cross project metrics calculations to compare multiple budget versions. In at least one of the various embodiments, three budget versions, FY Planned 1114, Old FY Planned 1116, and Final Budget 1118 may be evaluated using a cross project metric that may at least evaluate the cost for at least the following cost objects: Software 1104, Network 1106, Operations 1108, Data Storage 1110, and Telecom 1112.

In at least one of the various embodiments, the calculated cross project metric values for each cost object in each compared budget version may be listed in the results. In at least one of the various embodiments, if a cost object may not present in one of the compared budget versions a value of zero may be presented.

For example, in at least one of the various embodiments, Data Storage 1110 may not be present in the Old FY Planned budget version 1116. Accordingly, in at least one of the various embodiments, the resulting value 1120 for the costs associated with Data Storage for Old FY Planned budget version 1116 may be zero ($0.00).

In at least one of the various embodiments, an allocation rules may be configured to use one or more types of matching algorithms (e.g., matching rules), including, but not limited to, All/All (e.g., each source row matches all destination rows), All/Some (e.g., each source row matches some of the destination rows), Some/All (e.g., not all source rows are considered, but for those that are, they each match all destination rows), Some/Some (e.g., not all source rows are considered, not all destination rows are considered), or the like.

In at least one of the various embodiments, if applying allocation rules and/or entity propagation rules that selectively filter source or destination rows, a variety of filters and matching rules may be applied to determine if the rows match the allocation rules. In at least one of the various embodiments, rows may be filter and/or selected based on whether they include certain values, or ranges of values. Also, in at least one of the various embodiments, multiple values may be considered by build filter rules base on combining logical and/or mathematic expressions. For example, in at least one of the various embodiments, a filter may be city=‘Seattle’ or it may be city=‘Seattle’ or city=‘Portland’. Also, in at least one of the various embodiments, numerical values may be used such as quantity>5 and quantity<10, and the like.

In at least one of the various embodiments, matching rules may be generated by a user selecting them by way of a graphical user-interface (e.g., dialog boxes). In at least one of the various embodiments, such user-interfaces may be used for commonly used, and/or easier to generalize matching rules. In at least one of the various embodiments, other more complex and/or unique filters may generated by the user supplying programming and/or query language fragments that may define custom matching rules.

In at least one of the various embodiments, a manual allocation algorithm (e.g., an algorithm in which allocations are made based on human input) according to at least one of the various embodiments may employ a set of rules, including, mapping the source row to destination row based on entries made by one or more users.

Also, in at least one of the various embodiments, a user may enter and/or configure multiple matching rules that may be evaluated in turn against a source table until one of the rules matches. In at least one of the various embodiments, the multiple rules entered by a user may be multiple matching rules of different types, including those discussed above. In at least one of the various embodiments, multiple rules may be useful for mapping financial transaction ledgers (e.g., general ledger) into multiple objects.

In various embodiments, an allocation rules may be configured with a distribution strategy if the value from a source row may be split across multiple destination rows.

In at least one of the various embodiments, the value for each destination row from a particular source row may be calculated by dividing the source value by the number of destination rows (e.g., DESTINATION ROW VALUE=SOURCE ROW VALUE/Number of Destination Rows).

In at least one of the various embodiments, the value for each destination row from a particular source row may be calculated by multiplying by a factor for the particular destination row and dividing by the sum of the factors for all matching destination rows. (e.g., DESTINATION ROW VALUE=SOURCE ROW VALUE*DESTINATION ROW SomeColumn/SUM(DESTINATION ROW SomeColumn). Thus, the distribution rule may distribute the value from the source row to the destination row based on the simple weighting of the selected column in the destination table.

In at least one of the various embodiments, the value for each destination row from a particular source row may calculated by multiplying by a factor and dividing by a different factor. For example, in at least one of the various embodiments, such a rule may be represented by DESTINATION ROW VALUE=SOURCE ROW VALUE*SomeColumn/AnotherColumn.

In at least one of the various embodiments, the value for each destination row from a particular source row may be calculated using a factor calculated by looking at other parts of the model (e.g., other objects).

In at least one of the various embodiments, the rule may reference (utilize) a value computed by another rule (e.g., to weight by the cost computed from one or more rows in another object). One of ordinary skill in the art will appreciate how such dependencies influence the order of propagation rule selection for processing in block 2404 of FIG. 24.

In at least one of the various embodiments, handling reference circularities (e.g., “A” depends upon “B” but “B” depends upon “A”) may be treated as a system of simultaneous mathematical equations, and strategies for calculating an optimal result include substitution, elimination and, ultimately, running Monte Carlo simulations, or the like.

In at least one of the various embodiments, an arbitrary formula may be used to determine a distribution. In at least one of the various embodiments, such distribution formulas combine multiple of the above strategies or employ additional custom functions. For example, in at least one of the various embodiments, a weight factor could be calculated using logic expressions yielding distributions rules such as “Services with a HostCount>=10 should be weighted 4× higher than services with a HostCount<10.”

In at least one of the various embodiments, allocation ratio tables may be generated for entity propagation rules and/or allocation rules that may be based on database references between associated objects. In at least one of the various embodiments, each row in an allocation ratio table may correspond to an allocation from one item in the source object. In at least one of the various embodiments, in some cases multiple items from the source object may allocate to multiple items in the destination object. Similarly, in at least one of the various embodiments, individual items from the source object may allocate to multiple items in the destination object, or multiple items from the source object may allocate to a single item in the destination object.

In at least one of the various embodiments, if an allocation ratio table may be used, the distribution formula associated with the entity propagation rule may be applied to each row of the allocation ratio table. In at least one of the various embodiments, if a distribution rules may be applied to an allocation ratio table, the rows having the same source object item may be collapsed. Values in the collapsed rows may be added together to show a single value. FIG. 34 illustrates a use case involving an allocation ratio table.

In at least one of the various embodiments, allocation ratio tables may generated in advance, and/or cached as required.

It will be understood that figures, and combinations of actions in the flowchart-like illustrations, can be implemented by computer program instructions. These program instructions may be provided to a processor to produce a machine, such that the instructions executing on the processor create a means for implementing the actions specified in the flowchart blocks. The computer program instructions may be executed by a processor to cause a series of operational actions to be performed by the processor to produce a computer implemented process for implementing the actions specified in the flowchart block or blocks. These program instructions may be stored on some type of machine readable storage media, such as processor readable non-transitive storage media, or the like.

1. A computer implemented method for generating versions of a budget with a network device that is operative to perform actions, comprising:
modifying at least one version of the budget having a plurality of rules, wherein each modification to the at least one version of the budget is stored as at least one record in a data store;
generating at least one alternate budget version based on a state of the at least one version of the budget that is modified;
determining at least one other record that corresponds to at least one modification of the at least one version of the budget;
modifying the at least one alternate budget version based on execution of the at least one other record; and
enabling separate modification of each alternate version of the budget, wherein each alternate version of the budget is provided for comparison to at least one other version of the budget.

2. The method of claim 1, further comprising generating at least one tag that corresponds to at least one state of the at least one alternate budget version.

3. The method of claim 1, wherein generating the at least one alternate budget version further comprises employing at least one record stored in the data store.

4. The method of claim 1, further comprising preserving a state of each modification to the at least one modified version of the budget.

5. The method of claim 1, further comprising:
determining a final budget based on at least one of the modified version of the budget, alternate version of the budget, or the modified alternate version of the budget; and
generating at least one other version of the budget based on the determined final budget.

6. The method of claim 1, wherein enabling separate modification of each alternate version of the budget further comprises at least one of, adding, deleting, or modifying, the plurality of rules or budget data.

7. The method of claim 1, further comprising:
determining a plurality of budget versions for comparison;
determining at least one cross version metric;
generating a result value for the at least one cross version metric for each of the plurality of budget versions, wherein if a cost object referenced by the at least one cross version metric is absent, the result value is set to zero; and
generating a display of a combined report of each result of the at least one cross version metric evaluation.

8. A network device that is operative to generate versions of a budget, comprising:
a transceiver that is operative to communicate over a network;
a memory that is operative to store at least instructions; and
a processor device that is operative to execute instructions that enable actions, including:
modifying at least one version of the budget having a plurality of rules, wherein each modification to the at least one version of the budget is stored as at least one record in a data store;
generating at least one alternate budget version based on a state of the at least one version of the budget that is modified;
determining at least one other record that corresponds to at least one modification of the at least one version of the budget;
modifying the at least one alternate budget version based on execution of the at least one other record; and
enabling separate modification of each alternate version of the budget, wherein each alternate version of the budget is provided for comparison to at least one other version of the budget.

9. The network device of claim 8, further comprising generating at least one tag that corresponds to at least one state of the at least one alternate budget version.

10. The network device of claim 8, wherein generating the at least one alternate budget version further comprises employing at least one record stored in the data store.

11. The network device of claim 8, further comprising preserving a state of each modification to the at least one modified version of the budget.

12. The network device of claim 8, further comprising:
determining a final budget based on at least one of the modified version of the budget, alternate version of the budget, or the modified alternate version of the budget; and
generating at least one other version of the budget based on the determined final budget.

13. The network device of claim 8, wherein enabling separate modification of each alternate version of the budget further comprises at least one of, adding, deleting, or modifying, the plurality of rules or budget data.

14. The network device of claim 8, further comprising:
determining a plurality of budget versions for comparison;
determining at least one cross version metric;
generating a result value for the at least one cross version metric for each of the plurality of budget versions, wherein if a cost object referenced by the at least one cross version metric is absent, the result value is set to zero; and
generating a display of a combined report of each result of the at least one cross version metric evaluation.

15. A processor readable non-transitive storage media that includes instructions for generating versions of a budget, wherein execution of the instructions by a processor device enables actions, comprising:
modifying at least one version of the budget having a plurality of rules, wherein each modification to the at least one version of the budget is stored as at least one record in a data store;
generating at least one alternate budget version based on a state of the at least one version of the budget that is modified;
determining at least one other record that corresponds to at least one modification of the at least one version of the budget;
modifying the at least one alternate budget version based on execution of the at least one other record; and
enabling separate modification of each alternate version of the budget, wherein each alternate version of the budget is provided for comparison to at least one other version of the budget.

16. The media of claim 15, further comprising generating at least one tag that corresponds to at least one state of the at least one alternate budget version.

17. The media of claim 15, wherein generating the at least one alternate budget version further comprises employing at least one record stored in the data store.

18. The media of claim 15, further comprising preserving a state of each modification to the at least one modified version of the budget.

19. The media of claim 15, further comprising:
determining a final budget based on at least one of the modified version of the budget, alternate version of the budget, or the modified alternate version of the budget; and
generating at least one other version of the budget based on the determined final budget.

20. The media of claim 15, wherein enabling separate modification of each alternate version of the budget further comprises at least one of, adding, deleting, or modifying, the plurality of rules or budget data.

21. The media of claim 15, further comprising:
determining a plurality of budget versions for comparison;
determining at least one cross version metric;
generating a result value for the at least one cross version metric for each of the plurality of budget versions, wherein if a cost object referenced by the at least one cross version metric is absent, the result value is set to zero; and
generating a display of a combined report of each result of the at least one cross version metric evaluation.
